(19) United States
(12) Patent Application Publication
(10) Pub. No.: US 2021/0358305 A1
(43) Pub. Date: Nov. 18, 2021

(54) VEHICLE ALLOCATION DEVICE, VEHICLE, AND TERMINAL

(71) Applicant: TOYOTA JIDOSHA KABUSHIKI KAISHA, Aichi-ken (JP)

(72) Inventors: Hiroya CHIBA, Susono-shi (JP); Daiki YOKOYAMA, Gotemba-shi (JP); Kazuki FUJII, Hadano-shi (JP)

(21) Appl. No.: 17/228,708

(22) Filed: Apr. 13, 2021

(30) Foreign Application Priority Data
May 13, 2020 (JP) 2020-084802

(51) Int. Cl. G08G 1/00; G06N 3/04; G07C 5/08; G01C 21/34

(52) U.S. Cl. CPC G08G 1/202; G01C 21/3484; G07C 5/0841; G06N 3/04

(57) ABSTRACT

A vehicle allocation device for allocating a vehicle in response to a vehicle allocation request from a user terminal, includes a vehicle selector configured to select a vehicle having a relatively small learning amount in a category learnable while a user is driving from a plurality of vehicles learning a relation between input and output of a parameter related to traveling for each predetermined category in response to acquiring the vehicle allocation request, and output a vehicle allocation instruction to the selected vehicle.

The present application claims priority to and incorporates by reference the entire contents of Japanese Patent Application No. 2020-084802 filed in Japan on May 13, 2020.

### BACKGROUND

The present disclosure relates to a vehicle allocation device, a vehicle, and a terminal.

JP 2019-032625 A discloses a technique for preferentially allocating a vehicle in order from a vehicle having a low degree of progress in hydraulic control learning in a system for allocating a vehicle having a hydraulic control learning function of a power transmission device.

### SUMMARY

As illustrated in JP 2019-032625 A, in a system of allocating a vehicle based on a degree of progress in learning of classification learning, when a vehicle to be allocated acquires many pieces of teacher data in a certain category (traveling condition and traveling environment), the number of pieces of teacher data is biased with respect to teacher data in another category, and the accuracy of a learning result in the other category may be reduced.

There is a need for a vehicle allocation device, a vehicle, and a terminal capable of mitigating the bias of teacher data between categories.

According to one aspect of the present disclosure, there is provided a vehicle allocation device for allocating a vehicle in response to a vehicle allocation request from a user terminal, including a vehicle selector configured to select a vehicle having a relatively small learning amount in a category learnable while a user is driving from a plurality of vehicles learning a relation between input and output of a parameter related to traveling for each predetermined category in response to acquiring the vehicle allocation request, and output a vehicle allocation instruction to the selected vehicle.

According to another aspect of the present disclosure, there is provided a vehicle adapted to be allocated by a vehicle allocation device in response to a vehicle allocation request from a user terminal, wherein the vehicle is configured to: learn a relation between input and output of a parameter related to traveling for each of predetermined categories; and acquire a vehicle allocation instruction from the vehicle allocation device when a learning amount in a category learnable while the user is driving is relatively smaller than that of another vehicle to be allocated.

According to still another aspect of the present disclosure, there is provided a terminal for making a vehicle allocation request to a vehicle allocation device, the terminal including a vehicle allocation reservation unit configured to receive a vehicle allocation reservation from a user, output a vehicle allocation request to the vehicle allocation device based on the vehicle allocation reservation, and acquire information on a vehicle as vehicle-to-be-allocated information by outputting a vehicle allocation request to the vehicle allocation device, the vehicle being selected from a plurality of vehicles learning a relation between input and output of a parameter related to traveling for each of predetermined categories, and having a relatively small learning amount in a category learnable while the user is driving.

### BRIEF DESCRIPTION OF THE DRAWINGS

FIG. 1 schematically illustrates a vehicle allocation system including a vehicle allocation device, a vehicle, and a terminal according to a first embodiment;

FIG. 2 is a block diagram schematically illustrating each configuration of the vehicle allocation system according to the first embodiment;

FIG. 3 illustrates one example of a neural network;

FIG. 4 outlines a vehicle allocation method executed by the vehicle allocation system according to the first embodiment;

FIGS. 5A to 5C illustrate a selection method in the case where a plurality vehicles competes with each other in a vehicle allocation method executed by the vehicle allocation system according to the first embodiment;

FIG. 6 illustrates one example of a vehicle allocation reservation screen displayed on a terminal in the vehicle allocation method executed by the vehicle allocation system according to the first embodiment;

FIG. 7 illustrates one example of vehicle-to-be-allocated information displayed on a terminal in the vehicle allocation method executed by the vehicle allocation system according to the first embodiment;

FIG. 8 is a flowchart illustrating a flow of collecting and learning teacher data in the vehicle allocation method executed by the vehicle allocation system according to the first embodiment;

FIG. 9 is a flowchart illustrating a flow of a vehicle allocation reservation in the vehicle allocation method executed by the vehicle allocation system according to the first embodiment;

FIG. 10 is a block diagram schematically illustrating each configuration of a vehicle allocation system according to a second embodiment; and

FIG. 11 is a flowchart illustrating a flow of a vehicle allocation reservation in the vehicle allocation method executed by the vehicle allocation system according to the second embodiment.

### DETAILED DESCRIPTION

A vehicle allocation device, a vehicle, and a terminal according to embodiments of the present disclosure will be described with reference to the drawings. Note that components in the following embodiments include those that may be easily replaced by those skilled in the art, or those that are substantially the same.

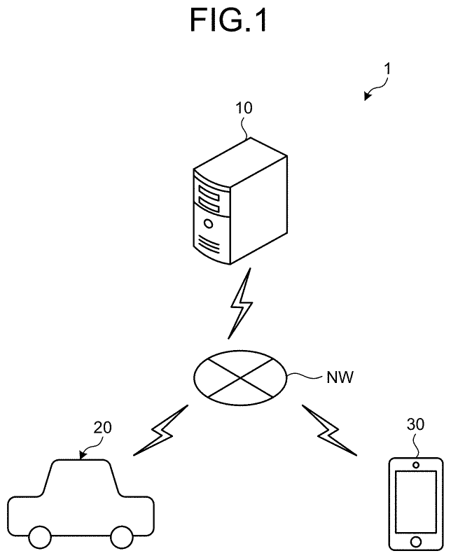

A vehicle allocation system according to a first embodiment will be described with reference to FIGS. 1 to 7. As illustrated in FIG. 1, a vehicle allocation system 1 according to the embodiment includes a vehicle allocation device 10, a vehicle 20, and a terminal 30. All of the vehicle allocation device 10, the vehicle 20, and the terminal 30 have a communication function, and may communicate with each other through a network NW. The network NW includes, for example, an internet network and a mobile phone network.

The vehicle allocation device 10 allocates the vehicle 20 to a user of the terminal 30 in response to a vehicle allocation request from the terminal 30. The vehicle allocation device 10 is implemented by a general-purpose computer such as a workstation and a personal computer.

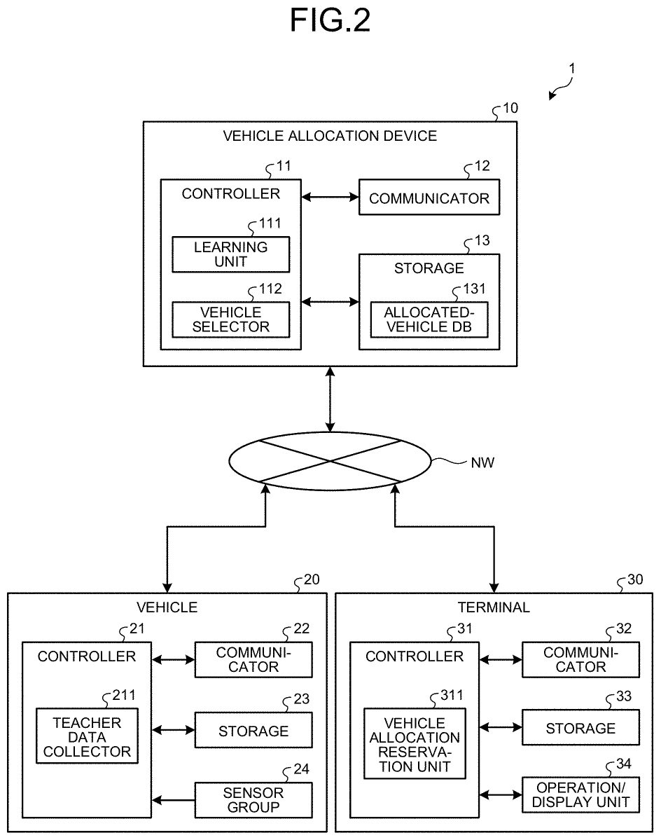

As illustrated in FIG. 2, the vehicle allocation device 10 includes a controller 11, a communicator 12, and a storage 13. Specifically, the controller 11 includes a processor and a memory (main storage). The processor includes, for example, a central processing unit (CPU), a digital signal processor (DSP), and a field-programmable gate array (FPGA). The memory includes, for example, a random access memory (RAM) and a read only memory (ROM).

The controller 11 loads a program stored in the storage 13 into a work area of the main storage, and executes the program. The controller 11 implements a function that matches a predetermined purpose by controlling, for example, each component through execution of the program. Specifically, the controller 11 functions as a learning unit 111 and a vehicle selector 112 through execution of the above-described program.

The learning unit 111 learns teacher data. The learning unit 111 acquires parameters (learning values) for each predetermined category collected by each vehicle 20 through the network NW from a plurality of vehicles 20 to be allocated. The parameters includes, for example, air temperature, humidity, air pressure, gradient, altitude, engine intake air amount, engine ignition timing, and engine exhaust temperature.

Subsequently, the learning unit 111 creates a learned model by performing machine learning using the above-described parameters as teacher data. Then, the learning unit 111 outputs the created learned model to each vehicle 20 through the network NW. A calculation load on the side of the vehicle 20 is reduced by the side of the vehicle allocation device 10 learning teacher data.

A machine learning method in the learning unit 111 is not particularly limited, and supervised learning such as a neural network, a support vector machine, a decision tree, simple Bayes, and a k-nearest neighbor algorithm may be used, for example. Furthermore, semi-supervised learning may be used instead of the supervised learning.

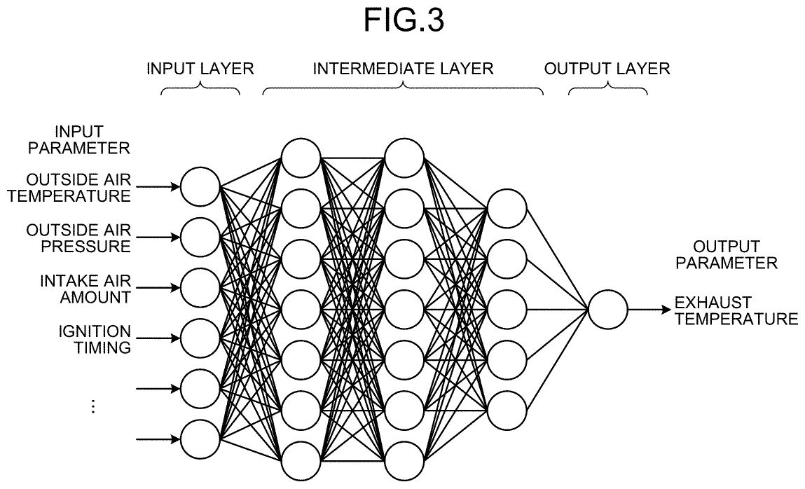

Hereinafter, a neural network will be described as one example of a specific machine learning method. As illustrated in FIG. 3, the neural network has an input layer, an intermediate layer, and an output layer. The input layer includes a plurality of nodes. Different input parameters are input to each node. An output from the input layer is input to the intermediate layer. Furthermore, the intermediate layer has a multi-layer structure including a layer composed of a plurality of nodes that receive input from the input layer. An output from the intermediate layer is input to the output layer. The output layer outputs an output parameter. Machine learning using a neural network in which the intermediate layer has a multi-layer structure is called deep learning. The figure illustrates an example in which the input parameter includes “outside air temperature, outside air pressure, intake air amount, and ignition timing”, and the output parameter includes “exhaust temperature”. The learning unit 111 creates a learned model by learning the relation between these input parameters and the output parameter.

The vehicle selector 112 selects the vehicle 20 to be allocated to the user of the terminal 30 from the plurality of vehicles 20. When acquiring a vehicle allocation request from the terminal 30 through the network NW, the vehicle selector 112 selects the vehicle 20 having a relatively small learning amount (number of pieces of teacher data) of a category learnable while the user is driving from a plurality of vehicles 20 learning the relation between input and output of parameters related to traveling for each predetermined category.

For example, when there are vehicles A to C . . . learning teacher data of categories A to D . . . as illustrated in Table 1 below, the vehicle selector 112 selects a vehicle C having the smallest number of pieces of teacher data of a category (e.g., category C) capable of being learned while the user drives from the vehicles A to C . . . .

TABLE 1

| | Number of | Number of | Number of | Number of | Number of |
|---|---|---|---|---|---|
| | pieces of | pieces of | pieces of | pieces of | pieces of |
| | teacher | teacher | teacher | teacher | teacher |
| | data of | data of | data of | data of | data of |
| | category | category | category | category | category |
| Vehicle | A | B | C | D | . . . |
| Vehicle | 20 | 80 | 120 | 30 | . . . |
| A | | | | | |
| Vehicle | 80 | 60 | 10 | 90 | . . . |
| B | | | | | |
| Vehicle | 20 | 30 | 0 | 20 | . . . |
| C | | | | | |
| . . . | . . . | . . . | . . . | . . . | . . . |

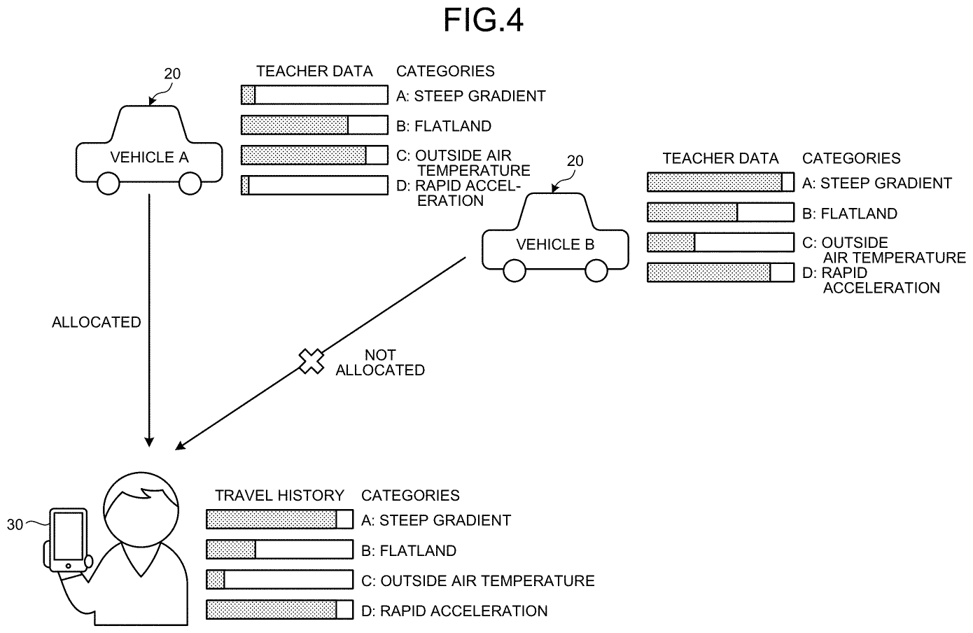

Furthermore, the vehicle selector 112 may select the vehicle 20 to be allocated to the user based on a past travel history of the user. A case will be discussed. In the case, for example, as illustrated in FIG. 4, the user has a travel history related to four categories (A: steep gradient, B: flatland, C: outside air temperature, D: rapid acceleration). The vehicles A and B learn teacher data of categories (A: steep gradient, B: flatland, C: outside air temperature, D: rapid acceleration) similar to the travel history of the user.

In the case, the vehicle selector 112 selects a category having a lot of travel histories (e.g., A: steep gradient and D: rapid acceleration) of the user, and selects, from the vehicles A and B, the vehicle A having the smallest learning amount (number of pieces of teacher data) of teacher data of a category selected from the travel history of the user. Then, the vehicle selector 112 outputs information on the selected vehicle A (hereinafter, referred to as “vehicle-to-be-allocated information”) to the terminal 30 of the user, and outputs a vehicle allocation instruction to the selected vehicle A. In the way, when acquiring a vehicle allocation request from a user who has a lot of travel histories of a certain category among a plurality of categories, the vehicle selector 112 selects the vehicle 20 having the smallest learning amount in teacher data of the certain category from the plurality of vehicles 20.

Here, the above-described “category” specifically indicates a traveling condition and a traveling environment of the vehicle 20, and includes, for example, low speed, high speed, uphill, downhill, high outside air temperature, low outside air temperature, rapid acceleration, ECO traveling, high rotation, low rotation, flatland, highland, low p road, high p road, and steep gradient.

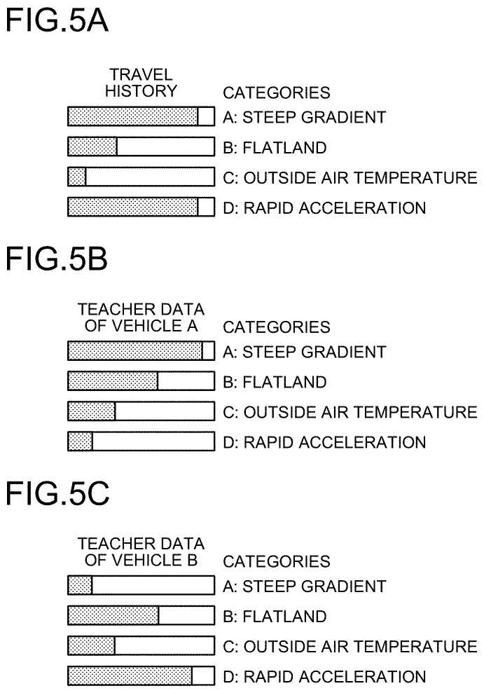

When a plurality of vehicles 20 competes with each other, the vehicle selector 112 may set priorities on the categories at the time of selecting a vehicle 20, and select one vehicle 20. A case will be discussed. In the case, for example, as illustrated in FIG. 5A, the user has a travel history related to four categories (A: steep gradient, B: flatland, C: outside air temperature, D: rapid acceleration). The vehicles A and B learn teacher data of categories (A: steep gradient, B: flatland, C: outside air temperature, D: rapid acceleration) similar to the travel history of the user.

In the case, for example, when “D: rapid acceleration” is set to have higher priority than “A: steep gradient”, the vehicle selector 112 selects the vehicle A (see FIG. 5B) having a small learning amount in “D: rapid acceleration” from the vehicles A and B. In contrast, for example, when “A: steep gradient” is set to have higher priority than “D: rapid acceleration”, the vehicle selector 112 selects the vehicle B (see FIG. 5C) having a small learning amount in “A: steep gradient” from the vehicles A and B. In the way, even when a plurality of vehicles 20 competes with each other, the vehicle 20 to be allocated may be selected by setting priorities on categories.

The communicator 12 includes, for example, a local area network (LAN) interface board and a wireless communication circuit for wireless communication. The communicator 12 is connected to the network NW such as the Internet, which is a public communication network. Then, the communicator 12 is connected to the network NW to perform communication between the vehicle 20 and the terminal 30.

The storage 13 includes a recording medium such as an erasable programmable ROM (EPROM), a hard disk drive (HDD), and a removable medium. Examples of the removable medium include disc recording media such as a universal serial bus (USB) memory, a compact disc (CD), a digital versatile disc (DVD), and a Blu-ray (registered trademark) disc (BD). The storage 13 may store, for example, an operating system (OS), various programs, various tables, and various databases.

The storage 13 includes an allocated-vehicle database (DB) 131. The allocated-vehicle DB 131 is built by a program of a database management system (DBMS) executed by the controller 11 managing data stored in the storage 13. The allocated-vehicle DB 131 includes, for example, a relational database in which teacher data for each vehicle 20 is retrievably stored.

Furthermore, the storage 13 stores, for example, a travel history of the user acquired from the vehicle 20 through the network NW and a learned model created by the learning unit 111 as needed in addition to the allocated-vehicle DB 131.

The vehicle 20 is a moving object capable of communicating with the outside, and is to be allocated to the user of the terminal 30 in response to a vehicle allocation request from the terminal 30. The vehicle 20 may be both a manually driven vehicle and an automatically driven vehicle.

Specifically, the vehicle 20 learns the relation between input and output of parameters related to traveling for each predetermined category, and outputs the learning result to the vehicle allocation device 10. Note that, in the embodiment, “learning” performed at the vehicle 20 means collecting various parameters during traveling (during vehicle allocation) and creating teacher data. Then, the “learning result” output to the vehicle allocation device 10 specifically means the teacher data.

When having a relatively smaller learning amount in the category learnable while the user is driving than that of another vehicle 20 to be allocated, the vehicle 20 acquires a vehicle allocation instruction from the vehicle allocation device 10. Note that, when having the smallest learning amount in the category learnable while the user is driving as compared to another vehicle 20 to be allocated, the vehicle 20 may acquire a vehicle allocation instruction from the vehicle allocation device 10.

As illustrated in FIG. 2, the vehicle 20 includes a controller 21, a communicator 22, a storage 23, and a sensor group 24. The controller 21 is an electronic control unit (ECU) that comprehensively controls the operations of various components mounted on the vehicle 20. The controller 21 functions as a teacher data collector 211 through execution of a program stored in the storage 23.

The teacher data collector 211 collects teacher data for each predetermined category. Note that, in the embodiment, the “teacher data” indicates a set of an input parameter and an output parameter necessary for machine learning. In this way, the teacher data collector 211 collects teacher data for learning, and sequentially outputs the teacher data to the vehicle allocation device 10, whereby various parameters may be learned.

Specifically, the teacher data collector 211 collects raw data of parameters with the sensor group 24 during traveling, and creates teacher data by performing predetermined preprocessing or the like on the raw data. Then, the teacher data collector 211 outputs the created teacher data to the vehicle allocation device 10 through the network NW.

The communicator 22 includes, for example, a data communication module (DCM), and performs communication between the vehicle allocation device 10 and the terminal 30 by wireless communication via the network NW. The storage 23 stores, for example, raw data of parameters collected by the teacher data collector 211, teacher data created by the teacher data collector 211, and travel histories of the user as needed.

The sensor group 24 detects and records parameters while the vehicle 20 is traveling. The sensor group 24 includes, for example, a vehicle speed sensor, an acceleration sensor, a GPS sensor, a traveling space sensor (3D-LiDAR), a millimeter wave sensor, a camera (imaging device), a temperature sensor, a humidity sensor, and air pressure sensor. The sensor group 24 outputs the raw data of the detected parameter to the teacher data collector 211.

The terminal 30 is a terminal device for making a vehicle allocation request to the vehicle allocation device 10 based on a user operation. The terminal 30 is implemented by, for example, a smartphone, a mobile phone, a tablet terminal, and a wearable computer owned by the user of the vehicle 20. As illustrated in FIG. 2, the terminal 30 includes a controller 31, a communicator 32, a storage 33, and the operation/display unit 34. The controller 31 functions as a vehicle allocation reservation unit 311 through execution of a program stored in the storage 33.

The vehicle allocation reservation unit 311 causes the operation/display unit 34 to display a vehicle allocation reservation screen, and receives a vehicle allocation reservation from a user through the vehicle allocation reservation screen. Subsequently, the vehicle allocation reservation unit 311 outputs a vehicle allocation request (vehicle allocation reservation information) to the vehicle allocation device 10 based on the vehicle allocation reservation. The vehicle allocation request includes, for example, a desired vehicle allocation time, an address of a place where a vehicle is to be allocated, a destination, and information for identifying a user (e.g., name and ID).

Subsequently, the vehicle allocation reservation unit 311 acquires information on the vehicle 20 from the vehicle allocation device 10 as the vehicle-to-be-allocated information. The vehicle 20 is selected from the plurality of vehicles 20 learning the relation between input and output of parameters related to traveling for each predetermined category, and has a relatively small learning amount in the category learnable while the user is driving. Then, the vehicle allocation reservation unit 311 causes the operation/display unit 34 to display the vehicle-to-be-allocated information. Note that, the vehicle allocation reservation unit 311 may acquire information on the vehicle 20 having the smallest learning amount in the category learnable while the user is driving from the vehicle allocation device 10 as vehicle-to-be-allocated information.

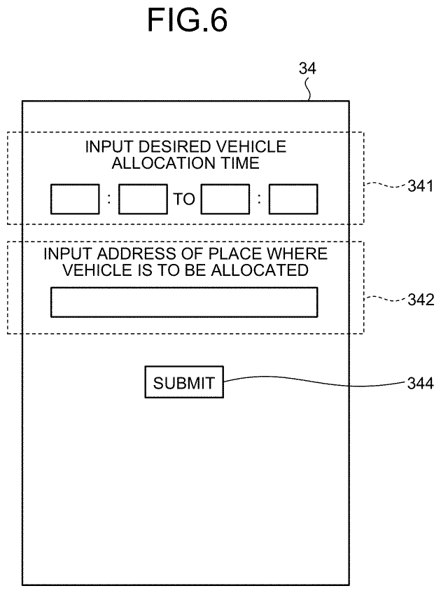

When making a vehicle allocation reservation, the vehicle allocation reservation unit 311 causes the operation/display unit 34 to display, for example, a vehicle allocation reservation screen as illustrated in FIG. 6. The vehicle allocation reservation screen is displayed by, for example, a user tapping an icon of a vehicle allocation application displayed on the operation/display unit 34 and activating the vehicle allocation application. An input field for a desired vehicle allocation time, an input field for an address of a place where a vehicle is to be allocated, and a submit button 344 are displayed in an area 341, an area 342, and a bottom line, respectively, on the vehicle allocation reservation screen in the figure. Note that, in addition to the items illustrated in the figure, the vehicle allocation reservation unit 311 may display an input field for information for identifying, for example, a destination and a user (e.g., name and ID).

When the user inputs all items on the vehicle allocation reservation screen and presses the submit button 344, the vehicle allocation reservation unit 311 outputs a vehicle allocation request including information input to these items to the vehicle allocation device 10.

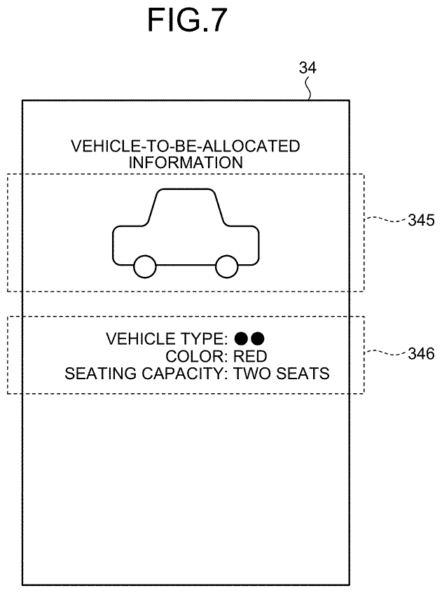

The vehicle selector 112 of the vehicle allocation device 10 that has acquired the vehicle allocation request selects a vehicle to be allocated with reference to the allocated-vehicle DB 131, and causes the operation/display unit 34 to display, for example, vehicle-to-be-allocated information as illustrated in FIG. 7. An image of a vehicle to be allocated and a vehicle type, color, and a seating capacity are displayed in an area 345 and an area 346, respectively, as the vehicle-to-be-allocated information illustrated in the figure.

The communicator 32 performs communication between the vehicle allocation device 10 and the vehicle 20 by wireless communication via the network NW. The storage 33 stores, for example, an application program (vehicle allocation application) for implementing the vehicle allocation reservation unit 311.

The operation/display unit 34 includes, for example, a touch panel display. The operation/display unit 34 has an input function and a display function. The input function is used for receiving an operation with, for example, a finger of a passenger in the vehicle 20 or a pen. The display function is used for displaying various pieces of information under the control of the controller 31. The operation/display unit 34 displays a vehicle allocation reservation screen (see FIG. 6) and a vehicle-to-be-allocated information (see FIG. 7) under the control of the vehicle allocation reservation unit 311.

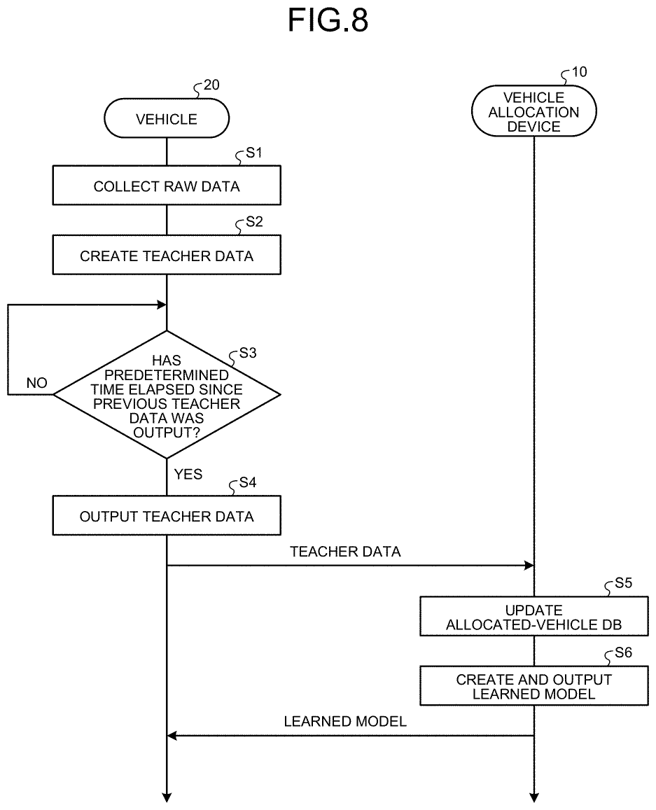

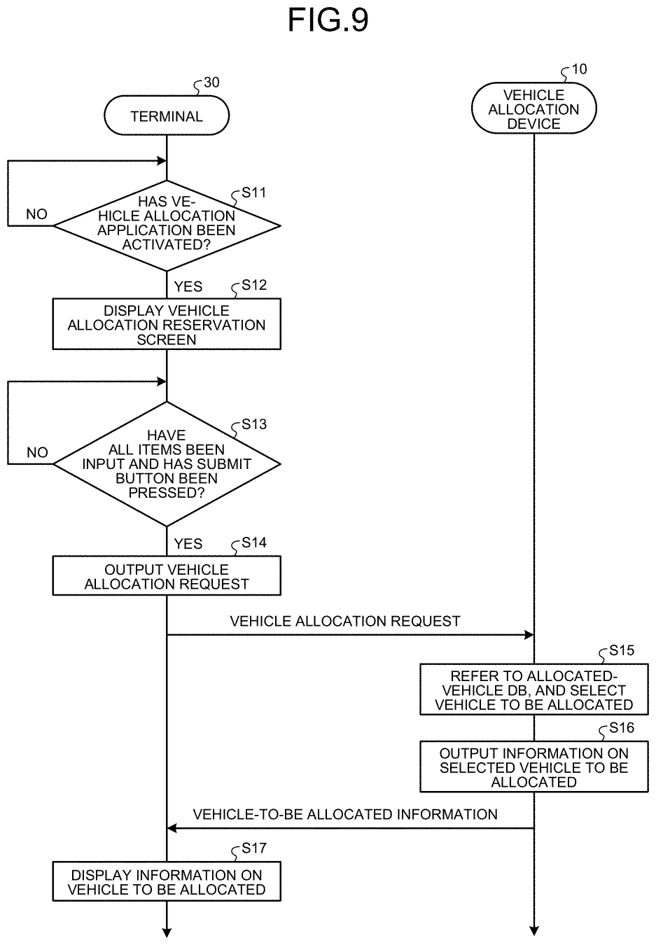

One example of processing procedures of a vehicle allocation method executed by the vehicle allocation system 1 according to the embodiment will be described with reference to FIGS. 8 and 9. In the following, FIG. 8 illustrates the flow of a step of collecting and learning teacher data with the vehicle 20 (hereinafter, referred to as a “learning step”) in the vehicle allocation system 1, and FIG. 9 illustrates the flow of a step of making a vehicle allocation reservation (hereinafter, referred to as a “vehicle allocation reservation step”) in the vehicle allocation system 1. Furthermore, in the following vehicle allocation reservation step, an example in which the vehicle 20 having the smallest learning amount in the category learnable while the user is driving is preferentially allocated will be described.

First, the teacher data collector 211 of the vehicle 20 collects raw data of parameters related to traveling through the sensor group 24 (Step S1). Subsequently, the teacher data collector 211 creates teacher data from the raw data (Step S2).

Subsequently, the teacher data collector 211 determines whether or not a predetermined time has elapsed since the previous teacher data was output to the vehicle allocation device 10 (Step S3). When determining that the predetermined time has elapsed since the previous teacher data was output to the vehicle allocation device 10 (Yes in Step S3), the teacher data collector 211 outputs the collected teacher data to the vehicle allocation device 10 (Step S4). Note that, when determining that the predetermined time has not elapsed since the previous teacher data was output to the vehicle allocation device 10 (No in Step S3), the teacher data collector 211 returns to Step S3.

Subsequently, the controller 11 of the vehicle allocation device 10 updates the allocated-vehicle DB 131 by storing the teacher data in the allocated-vehicle DB 131 (Step S5). Subsequently, the learning unit 111 of the vehicle allocation device 10 creates a learned model by performing machine learning on the teacher data, and outputs the created learned model to the vehicle 20 (Step S6). With the above, the processing of the learning step of the vehicle allocation method ends.

First, the vehicle allocation reservation unit 311 of the terminal 30 determines whether or not a user has tapped an icon of a vehicle allocation application displayed on the operation/display unit 34 and has activated the vehicle allocation application (Step S11). When determining that the vehicle allocation application has been activated (Yes in Step S11), the vehicle allocation reservation unit 311 causes the operation/display unit 34 to display the vehicle allocation reservation screen (see FIG. 6) (Step S12). Note that, when determining that the vehicle allocation application has not been activated (No in Step S11), the vehicle allocation reservation unit 311 returns to Step S11.

Subsequently, the vehicle allocation reservation unit 311 determines whether or not all items on the vehicle allocation reservation screen have been input and the submit button 344 has been pressed (Step S13). When determining that all items on the vehicle allocation reservation screen have been input and the submit button 344 has been pressed (Yes in Step S13), the vehicle allocation reservation unit 311 outputs a vehicle allocation request to the vehicle allocation device 10 (Step S14). Note that, when determining that either of the items on the vehicle allocation reservation screen has not been input or the submit button 344 has not been pressed (No in Step S13), the vehicle allocation reservation unit 311 returns to Step S13.

Subsequently, the vehicle selector 112 of the vehicle allocation device 10 refers to the allocated-vehicle DB 131, and selects a vehicle to be allocated (Step S15). In Step S15, the vehicle selector 112 selects the vehicle 20 having the smallest learning amount in the category learnable while the user is driving from a plurality of vehicles 20 learning the relation between input and output of parameters related to traveling for each predetermined category. That is, the vehicle selector 112 first narrows down the vehicles 20 learning parameters of a category learnable while the user is driving from the plurality of vehicles 20. Then, the vehicle selector 112 refers to the allocated-vehicle DB 131, and selects the vehicle 20 having the smallest number of pieces of teacher data among the vehicles 20 that have been narrowed down as a vehicle to be allocated.

Subsequently, the vehicle selector 112 outputs information on the selected vehicle to be allocated to the terminal 30 (Step S16). In response, the vehicle allocation reservation unit 311 causes the operation/display unit 34 to display the vehicle-to-be-allocated information (see FIG. 7) (Step S17). Note that, in Step S16, the vehicle selector 112 outputs the vehicle-to-be-allocated information to the terminal 30, and also outputs a vehicle allocation instruction to the selected vehicle 20. With the above, the processing of the vehicle allocation reservation step of the vehicle allocation method ends.

According to the vehicle allocation device 10, the vehicle 20, and the terminal 30 according to the above-described first embodiment, a vehicle 20 not progressing ahead in learning teacher data of a category learnable while a user is driving among vehicles 20 to be allocated is preferentially allocated, so that the bias of the number of pieces of teacher data between categories is mitigated, and the accuracy of the learning result in each vehicle 20 is improved.

When a vehicle performing AI learning is allocated, the learning situation differs between vehicles to be allocated, so that a situation where learning is not performed extremely depending on a vehicle may occur. In contrast, according to the vehicle allocation device 10, the vehicle 20, and the terminal 30 according to the first embodiment, the vehicle 20 not progressing ahead in learning is preferentially allocated, which may inhibit the situation where learning is not performed in a certain category.

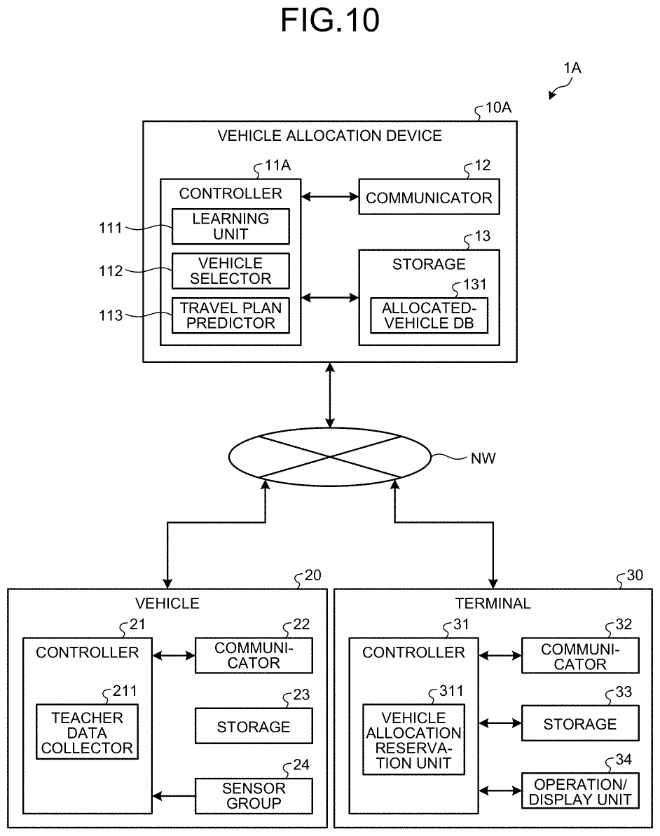

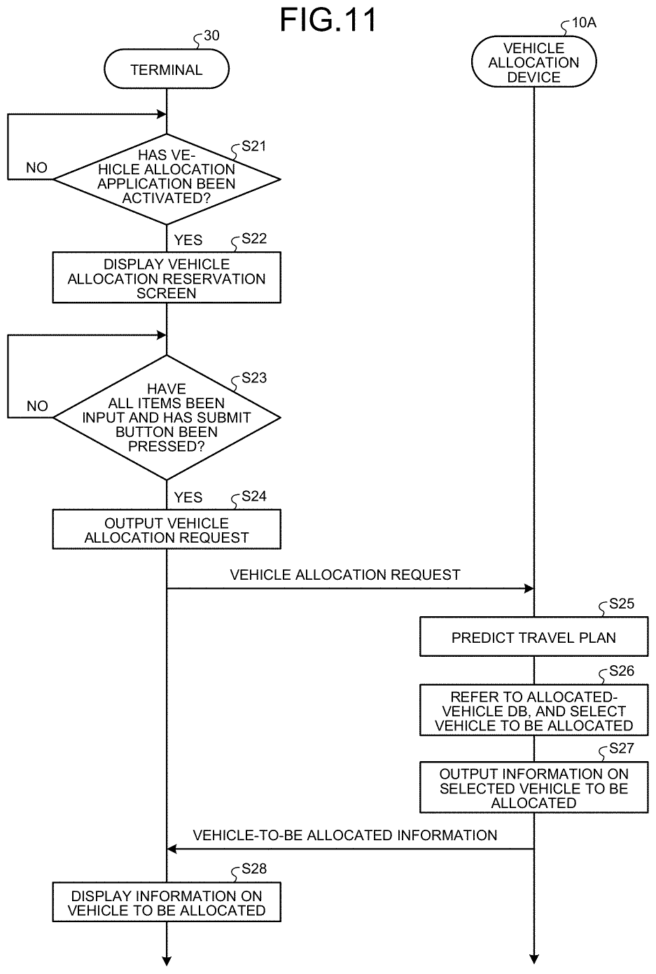

A vehicle allocation system according to a second embodiment will be described with reference to FIGS. 10 and 11. As illustrated in FIG. 10, a vehicle allocation system 1A according to the embodiment includes a vehicle allocation device 10A, the vehicle 20, and the terminal 30. All of the vehicle allocation device 10A, the vehicle 20, and the terminal 30 have a communication function, and may communicate with each other through the network NW. In the following, the description of a configuration similar to that of the above-described vehicle allocation system 1 (see FIG. 2) will be omitted.

As illustrated in FIG. 10, the vehicle allocation device 10A includes a controller 11A, the communicator 12, and the storage 13. The controller 11A functions as a travel plan predictor 113 in addition to the learning unit 111 and the vehicle selector 112.

The travel plan predictor 113 predicts a travel plan of a user based on information on a destination included in a vehicle allocation request and a travel history of the user. The “travel plan” indicates information on, for example, which area and under what traveling condition (category) the user travels. When the travel plan predictor 113 predicts a travel plan of the user, the vehicle selector 112 selects, from a plurality of vehicles 20, the vehicle 20 having the smallest learning amount in category included in the travel plan predicted at the travel plan predictor 113.

One example of processing procedures of a vehicle allocation method executed by the vehicle allocation system 1A according to the embodiment will be described with reference to FIG. 11. Note that, in the vehicle allocation system 1A, the flow of the learning step is similar to that in the first embodiment (see FIG. 8). The flow of the vehicle allocation reservation step will be described below. Furthermore, in the following vehicle allocation reservation step, an example in which the vehicle 20 having the smallest learning amount in the category learnable while the user is driving is preferentially allocated will be described.

First, the vehicle allocation reservation unit 311 of the terminal 30 determines whether or not a user has tapped an icon of a vehicle allocation application displayed on the operation/display unit 34 and has activated the vehicle allocation application (Step S21). When determining that the vehicle allocation application has been activated (Yes in Step S21), the vehicle allocation reservation unit 311 causes the operation/display unit 34 to display the vehicle allocation reservation screen (see FIG. 6) (Step S22). Note that, when determining that the vehicle allocation application has not been activated (No in Step S21), the vehicle allocation reservation unit 311 returns to Step S21.

Subsequently, the vehicle allocation reservation unit 311 determines whether or not all items on the vehicle allocation reservation screen have been input and the submit button 344 has been pressed (Step S23). When determining that all items on the vehicle allocation reservation screen have been input and the submit button 344 has been pressed (Yes in Step S23), the vehicle allocation reservation unit 311 outputs a vehicle allocation request to the vehicle allocation device 10A (Step S24). Note that, when determining that either of the items on the vehicle allocation reservation screen has not been input or the submit button 344 has not been pressed (No in Step S23), the vehicle allocation reservation unit 311 returns to Step S23.

Subsequently, the travel plan predictor 113 of the vehicle allocation device 10A predicts a travel plan of the user based on information on a destination included in a vehicle allocation request and a travel history of the user (Step S25). Subsequently, the vehicle selector 112 refers to the allocated-vehicle DB 131, and selects a vehicle to be allocated (Step S26). In Step S15, the vehicle selector 112 first narrows down the vehicle 20 learning a parameter of a category included in the travel plan predicted in Step S25 from a plurality of vehicles 20. Then, the vehicle selector 112 refers to the allocated-vehicle DB 131, and selects the vehicle 20 having the smallest number of pieces of teacher data among the vehicles 20 that have been narrowed down as a vehicle to be allocated.

Subsequently, the vehicle selector 112 outputs information on the selected vehicle to be allocated to the terminal 30 (Step S27). In response, the vehicle allocation reservation unit 311 causes the operation/display unit 34 to display the vehicle-to-be-allocated information (see FIG. 7) (Step S28). Note that, in Step S27, the vehicle selector 112 outputs the vehicle-to-be-allocated information to the terminal 30, and also outputs a vehicle allocation instruction to the selected vehicle 20. With the above, the processing of the vehicle allocation reservation step of the vehicle allocation method ends.

According to the vehicle allocation device 10A, the vehicle 20, and the terminal 30 according to the above-described second embodiment, a vehicle 20 not progressing ahead in learning a category learnable while a user is driving among vehicles 20 to be allocated is preferentially allocated, so that the bias of the number of pieces of teacher data between categories is mitigated, and the accuracy of the learning result in each vehicle 20 is improved.

Furthermore, for example, when on-board learning is performed by using a computer (controller 21) mounted on each vehicle 20 in the vehicle 20 for car sharing, biased traveling condition (e.g., flatland) for each vehicle 20 causes biased learning of each vehicle 20, which causes a possibility that a problem peculiar to another traveling condition (e.g., steep gradient) may not be addressed. In contrast, according to the vehicle allocation device 10A, the vehicle 20, and the terminal 30 according to the second embodiment, a travel plan (traveling condition) of a user of the vehicle 20 is predicted, and the vehicle 20 may be allocated based on the prediction result such that the bias of learning between the vehicles 20 is eliminated.

Additional effects and variations may be easily derived by those skilled in the art. Accordingly, the broader aspects are not limited to the particular details and representative embodiments illustrated and described above. Consequently, various modifications may be made without departing from the spirit or scope of the general inventive concept defined by the appended claims and equivalents thereof.

For example, although, in the above-described vehicle allocation reservation steps (see FIGS. 9 and 11) of the vehicle allocation systems 1 and 1A, a case where the vehicle 20 having the smallest number of pieces of teacher data is selected and allocated has been described, the vehicle 20 may be selected in accordance with another condition from vehicles 29 having less than a predetermined number of pieces of teacher data. Alternatively, whether allocation is possible or not may be determined in order from the vehicle 20 having the smallest number of pieces of teacher data, and a vehicle 20 that has first been determined as possible may be selected.

Furthermore, although, in the above-described vehicle allocation systems 1 and 1A, raw data is collected and teacher data is created on the side of the vehicle 20, and teacher data is learned and learned data is created on the sides of the vehicle allocation devices 10 and 10A, a subject that creates the teacher data and a subject of learning are not limited to these systems and devices.

In the vehicle allocation systems 1 and 1A, for example, raw data may be collected on the side of the vehicle 20, and teacher data may be created, teacher data may be learned, and learned data may be created on the sides of the vehicle allocation devices 10 and 10A. Furthermore, raw data may be collected, teacher data may be created, teacher data may be learned, and learned data may be created on the side of the vehicle 20.

Furthermore, although, in the vehicle allocation systems 1 and 1A, the teacher data collector 211 of the vehicle 20 collects various parameters, various parameters may be acquired and used by, for example, road-to-vehicle communication and vehicle-to-vehicle communication.

Furthermore, although the above-described vehicle allocation systems 1 and 1A are described assuming a scene in which a vehicle is allocated to a user on a common public road, the vehicle allocation systems 1 and 1A may be applied to vehicle allocation service using automatically driven vehicles in, for example, a connected city in which all goods and services are connected by information.

According to the present disclosure, a vehicle not progressing ahead in learning a category learnable while a user is driving is preferentially allocated, so that the bias of the number of pieces of teacher data between categories is mitigated, and the accuracy of the learning result in each vehicle is improved.

Moreover, a vehicle not progressing ahead in learning a category learnable while a user is driving among vehicles to be allocated is preferentially and easily allocated.

Moreover, a vehicle least progressing ahead in learning a category learnable while a user is driving among vehicles to be allocated is preferentially allocated.

Moreover, a vehicle to be allocated may be selected based on a travel history of a user.

Moreover, a vehicle to be allocated may be selected based on a travel plan predicted from a travel history of a user.

Moreover, a calculation load on the side of a vehicle is reduced by the side of a vehicle allocation device learning teacher data.

Moreover, various parameters may be learned. Moreover, a vehicle not progressing ahead in learning a category learnable while a user is driving among vehicles to be allocated is preferentially and easily allocated.

Moreover, a vehicle least progressing ahead in learning a category learnable while a user is driving among vehicles to be allocated is preferentially allocated.

Moreover, various parameters may be learned.

Moreover, a vehicle not progressing ahead in learning a category learnable while a user is driving among vehicles to be allocated is preferentially and easily allocated.

Moreover, a vehicle least progressing ahead in learning a category learnable while a user is driving among vehicles to be allocated is preferentially allocated.

Moreover, various parameters may be learned. Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle allocation device for allocating a vehicle in response to a vehicle allocation request from a user terminal, comprising
a vehicle selector configured to
select a vehicle having a relatively small learning amount in a category learnable while a user is driving from a plurality of vehicles learning a relation between input and output of a parameter related to traveling for each of predetermined categories in response to acquiring the vehicle allocation request, and
output a vehicle allocation instruction to the selected vehicle.

2. The vehicle allocation device according to claim 1, wherein the vehicle selector is configured to
select a vehicle having a smallest learning amount in the category learnable from the plurality of vehicles, and
output the vehicle allocation instruction to the selected vehicle.

3. The vehicle allocation device according to claim 1, wherein the vehicle selector is configured to select, in response to acquiring the vehicle allocation request from a user who has a lot of travel histories of a certain category among the predetermined categories, a vehicle having a smallest learning amount in the certain category from the plurality of vehicles .

4. The vehicle allocation device according to claim 1, further comprising a travel plan predictor configured to predict a travel plan of the user based on a destination included in the vehicle allocation request and a travel history of the user,
wherein the vehicle selector is configured to select a vehicle having a smallest learning amount in a category included in a travel plan predicted at the travel plan predictor from the plurality of vehicles.

5. The vehicle allocation device according to claim 1, further comprising a learning unit configured to learn a parameter collected by each of the plurality of vehicles as teacher data.

6. The vehicle allocation device according to claim 1, wherein the parameter includes air temperature, humidity, air pressure, gradient, altitude, engine intake air amount, engine ignition timing, and engine exhaust temperature.

7. A vehicle adapted to be allocated by a vehicle allocation device in response to a vehicle allocation request from a user terminal, wherein the vehicle is configured to:
learn a relation between input and output of a parameter related to traveling for each of predetermined categories; and
acquire a vehicle allocation instruction from the vehicle allocation device when a learning amount in a category learnable while the user is driving is relatively smaller than that of another vehicle to be allocated.

8. The vehicle according to claim 7, wherein the vehicle is configured to acquire the vehicle allocation instruction from the vehicle allocation device when having a smallest learning amount in the category learnable while the user is driving as compared to the other vehicle to be allocated.

9. The vehicle according to claim 7, wherein the parameter includes air temperature, humidity, air pressure, gradient, altitude, engine intake air amount, engine ignition timing, and engine exhaust temperature.

10. A terminal for making a vehicle allocation request to a vehicle allocation device, the terminal comprising
a vehicle allocation reservation unit configured to
receive a vehicle allocation reservation from a user,
output a vehicle allocation request to the vehicle allocation device based on the vehicle allocation reservation, and
acquire information on a vehicle as vehicle-to-be-allocated information by outputting a vehicle allocation request to the vehicle allocation device, the vehicle being selected from a plurality of vehicles learning a relation between input and output of a parameter related to traveling for each of predetermined categories, and having a relatively small learning amount in a category learnable while the user is driving.

11. The terminal according to claim 10, wherein the vehicle allocation reservation unit is configured to acquire the information on a vehicle as vehicle-to-be-allocated information by outputting the vehicle allocation request to the vehicle allocation device, the vehicle being selected from the plurality of vehicles learning the relation between input and output of the parameter related to traveling for each of the predetermined categories, and having a smallest learning amount in the category learnable while the user is driving.

12. The terminal according to claim 10, wherein the parameter includes air temperature, humidity, air pressure, gradient, altitude, engine intake air amount, engine ignition timing, and engine exhaust temperature.
